(19) United States
(12) Patent Application Publication
(10) Pub. No.: US 2006/0087574 A1
(43) Pub. Date: Apr. 27, 2006

(54) Control device for charge transfer element

(76) Inventor: Takashi Tanimoto, Motosu-Gun (JP)

Correspondence Address: CANTOR COLBURN, LLP, 55 GRIFFIN ROAD SOUTH, BLOOMFIELD, CT, 06002, US

(21) Appl. No.: 11/251,031

(22) Filed: Oct. 14, 2005

(30) Foreign Application Priority Data
Oct. 22, 2004 (JP) 2004-307615

(51) Int. Cl. H04N 5/335

(52) U.S. Cl. 348/294

(57) ABSTRACT

The present invention provides a control device including a negative voltage generating section that outputs a voltage from an output end that can be grounded via a capacitor, an inverter that receives a clock control signal to output a charged voltage of the capacitor to the outside at predetermined points in time, a pulse generating section that receives a pulse control signal to output a pulse voltage from an output end that can be connected to an output end of the negative voltage generating section via the capacitor, and a control section which outputs a clock control signal to the inverter and which controls the pulse control signal at predetermined points in time under the control of the clock control signal. This makes it possible to reduce the magnitude of a variation in a control voltage for a charge transfer element without the need to increase the size of the device.

### CROSS-REFERENCE TO RELATED APPLICATIONS

The entire disclosures of Japanese Patent Application No. 2004-307615 including specification, claims, drawings, and abstract is incorporated herein by reference.

### BACKGROUND OF THE INVENTION

1. Field of the Invention

The present invention relates to a control device for a charge transfer element that can supply a stable driving voltage regardless of a variation in load.

2. Description of the Related Art

FIG. 4 is a schematic diagram showing the configuration of a CCD solid image pickup element based on a frame transfer scheme. The CCD solid image pickup element based on the frame transfer scheme is basically composed of an image pickup section 10i, a storage section 10s, a horizontal transfer section 10h, and an output section 10d.

In the image pickup section 10i, pixels of photoelectric converting elements are arranged in a matrix. In the image pickup section 10i, a plurality of photoelectric converting elements are arranged in columns extended in a direction toward the storage section 10s. The columns also serve as vertical shift registers and are arranged parallel to one another. The storage section 10s is composed of vertical shift registers continuous with the vertical shift registers in the image pickup section 10i.

The photoelectric converting elements convert light incident on the image pickup section 10i into information charges for respective pixels. The information charges for each frame are collectively transferred by vertical pulses φᵥᵢ and φᵥₛ applied by a control device to the vertical shift registers in the image pickup section 10i and storage section 10s. The storage section 10s receives and temporarily holds the information charges for each frame transferred by the image pickup section 10i. Subsequently, the vertical clock pulses φᵥₛ applied to the vertical shift registers transfer the information charges to the horizontal transfer section 10h row by row. The horizontal transfer section 10h is composed of one row of horizontal shift registers extended in a direction toward the output section 10d. The horizontal transfer section 10h receives the information charges transferred by the storage section 10s. The horizontal transfer section 10h then sequentially transfers the information charges for each pixel to the output section 10d. The output section 10d converts an amount of charges for each pixel into a voltage value. A variation in voltage value is then obtained and serves as a CCD output.

FIG. 5 shows the configuration of a control device for a charge transfer element such as a CCD solid image pickup element; the control device supplies the vertical clock pulses φᵥᵢ and φᵥₛ when the charge transfer element transfers information charges. The control device for the charge transfer element is comprised of a negative voltage generating section 12, a capacitor 14, an inverter 16, and a control section 18.

The negative voltage generating section 12 generates a negative output voltage with respect to a reference potential (for example, a ground potential GND). An output end of the negative voltage generating section 12 is grounded via the capacitor 14. Accordingly, the capacitor 14 is charged by an output voltage from the negative voltage generating section 12. The capacitor 14 supplies a charged voltage to the inverter 16.

The inverter 16 is composed of a P channel MOS transistor 16a and an N channel MOS transistor 16b connected together in series. A positive power supply is connected to a drain of the transistor 16a. An output end of the negative voltage generating section 12 is connected to a drain of the transistor 16b. A source of the transistor 16a is connected to a source of the transistor 16b to constitute an output end of the inverter 16. The inverter 16 is provided for each of the transfer electrodes of the vertical shift registers, and the output end of the inverter is connected to each of the transfer electrodes of the vertical shift registers. The transistors 16a and 16b of the inverter 16 are controllably turned on and off to output an output voltage V_{OUT} in which a positive and negative voltage are alternately repeated, that is, the vertical clock pulses φᵥᵢ and φᵥₛ.

The control section 18 supplies a clock control signal SC to the inverter 16. To make the output voltage V_{OUT} (vertical clock pulses φᵥᵢ and φᵥₛ) positive, the clock control signal SC is set to a low level. To make the output voltage V_{OUT} (vertical clock pulses φᵥᵢ and φᵥₛ) negative, the clock control signal SC is set to a high level. The control section 18 transfers information charges in a vertical direction by varying the clock control signal for the inverter 16 provided for each row of the vertical shift registers.

With the control device for the charge transfer element in accordance with the prior art, as shown in FIG. 6, when frames start to be transferred from the image pickup section 10i to the storage section 10s, the vertical clock pulses φᵥᵢ and φᵥₛ are supplied simultaneously to the large number of transfer electrodes of the vertical shift registers. This rapidly increases the quantity of discharge current from the capacitor 14, resulting in a variation ΔVc in the charged voltage Vc of the capacitor 14. Thus, the output voltage V_{OUT} also varies, disadvantageously making the transfer of charges unstable.

To reduce the magnitude of the variation ΔVc, it is possible to increase the capacitance of the capacitor 14. However, the element size of the capacitor 14 increases consistently with the capacitance of the capacitor 14. This disadvantageously increases the module size of the control device.

### SUMMARY OF THE INVENTION

The present invention provides a control device characterized by comprising a voltage generating section that outputs a voltage from an output end that can be connected to an end of a first capacitor, a pulse generating section that outputs a pulse voltage, on the basis of a pulse control signal, from an output end that can be connected to the output end of the voltage generating section via a second capacitor, and a control section that controls the pulse control signal so that the pulse generating section outputs a pulse voltage at predetermined points in time.

### BRIEF DESCRIPTION OF THE DRAWINGS

Preferred embodiments of the present invention will be described in detail based on the following drawings, wherein:

FIG. 1 is a diagram showing the configuration of a control device for a charge transfer element in accordance with an embodiment of the present invention;

FIG. 2 is a diagram showing an example of configuration of a pulse generating section in accordance with the embodiment of the present invention;

FIG. 3 is a chart showing control timings used by the control device for the charge transfer element in accordance with the embodiment of the present invention;

FIG. 4 is a diagram showing a solid image pickup element;

FIG. 5 is a diagram showing the configuration of a control device for a charge transfer element in accordance with the related art; and

FIG. 6 is a chart showing control timings used by the control device for the charge transfer element in accordance with the related art.

### DESCRIPTION OF THE PREFERRED EMBODIMENTS

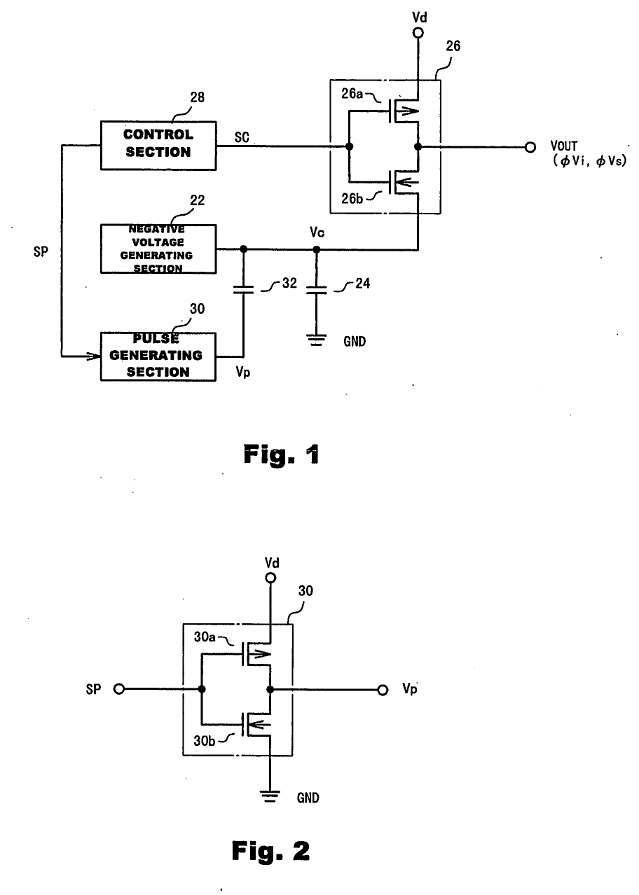

FIG. 1 shows a control device for a charge transfer element in accordance with an embodiment of the present invention. The control device includes a negative voltage generating section 22, a capacitor 24, an inverter 26, a control section 28, a pulse generating section 30, and a capacitor 32. The control device is formed into modules, and in general, all the components except the capacitors 24 and 32, that is, the negative voltage generating section 22, inverter 26, control section 28, and pulse generating section 30, are formed into one or more semiconductor elements, while the capacitors 24 and 32 are connected to the semiconductor elements as external elements.

The negative voltage generating section 22 generates a negative output voltage with respect to a reference potential (for example, a ground potential GND) as in the case of the conventional control device. An output end of the negative voltage generating section 22 is grounded via the capacitor 24. Consequently, the capacitor 24 is charged by an output voltage from the negative voltage generating section 22. The capacitor 24 supplies a charged voltage Vc to the inverter 26.

The inverter 26 is composed of a P channel MOS transistor 26a and an N channel MOS transistor 26b connected together in series. The inverter 26 functions as a switch circuit that causes the capacitor 24 to output the charged voltage to the outside at predetermined points in time on the basis of a clock control signal SC output by the control section 28. A positive power supply (for example, a system power supply Vd for a solid image pickup element) is connected to a drain of the transistor 26a. An output end of the negative voltage generating section 22 is connected to a drain of the transistor 26b. A source of the transistor 26a is connected to a source of the transistor 26b to constitute an output end of the inverter 26. The inverter 26 is provided for each of the transfer electrodes of vertical shift registers. Each transfer electrode connects to the output end of the corresponding inverter 26. The transistors 26a and 26b are controllably turned on and off to apply, to each of the transfer electrodes of the vertical shift registers, an output voltage V_{OUT} (vertical clock pulses φᵥᵢ and φᵥₛ) in which a positive and negative voltage are alternately repeated.

Upon receiving a pulse control signal SP, described later, the pulse generating section 30 generates a positive pulse voltage V_{P} having a polarity opposite to that for the negative voltage generating section 22 with respect to the reference potential (for example, ground potential GND). In this case, the absolute value of the pulse voltage V_{P} is suitably equal to or smaller than that of the output voltage from the negative voltage generating section 22. An output end of the pulse generating section 30 is connected to an output end of the negative voltage generating section 22 via the capacitor 32.

The pulse generating section 30 includes an inverter circuit composed of a P channel MOS transistor 30a and an N channel MOS transistor 30b connected together in series, for example, as shown in FIG. 2. A positive power supply (for example, the system power supply Vd for the solid image pickup element) is connected to a drain of the transistor 30a. A drain of the transistor 30b is grounded. A source of the transistor 30a is connected to a source of the transistor 30b to constitute an output end of the pulse generating section 30. A pulse control signal SP is supplied to gates of the transistors 30a and 30b. With this configuration, a pulse voltage V_{P} can be output from the output end of the pulse generating section 30 by changing the pulse control signal SP to a positive or negative voltage.

The control section 28 supplies a clock control signal SC to the inverter 26. To make the output voltage V_{OUT} (vertical clock pulses φᵥᵢ and φᵥₛ) positive, the clock control signal SC is set to a low level (negative potential). This turns on the transistor 26a, while turning off the transistor 26b. The positive power supply voltage Vd is then output from the output end. On the other hand, to make the output voltage V_{OUT} (vertical clock pulses φᵥᵢ and φᵥₛ) negative, the clock control signal SC is set to a high level (positive potential). This turns off the transistor 26a, while turning on the transistor 26b. The negative voltage Vc charged in the capacitor 24 is then applied to the output end.

The control section 28 varies the clock control signal for the inverter 26 provided for each of the transfer electrodes of the vertical shift registers at predetermined points in time. The control section 28 thus differently varies a plurality of phases into which the vertical clock pulses φᵥᵢ and φᵥₛ applied to each of the transfer electrodes of the vertical shift registers are divided, to transfer information charges.

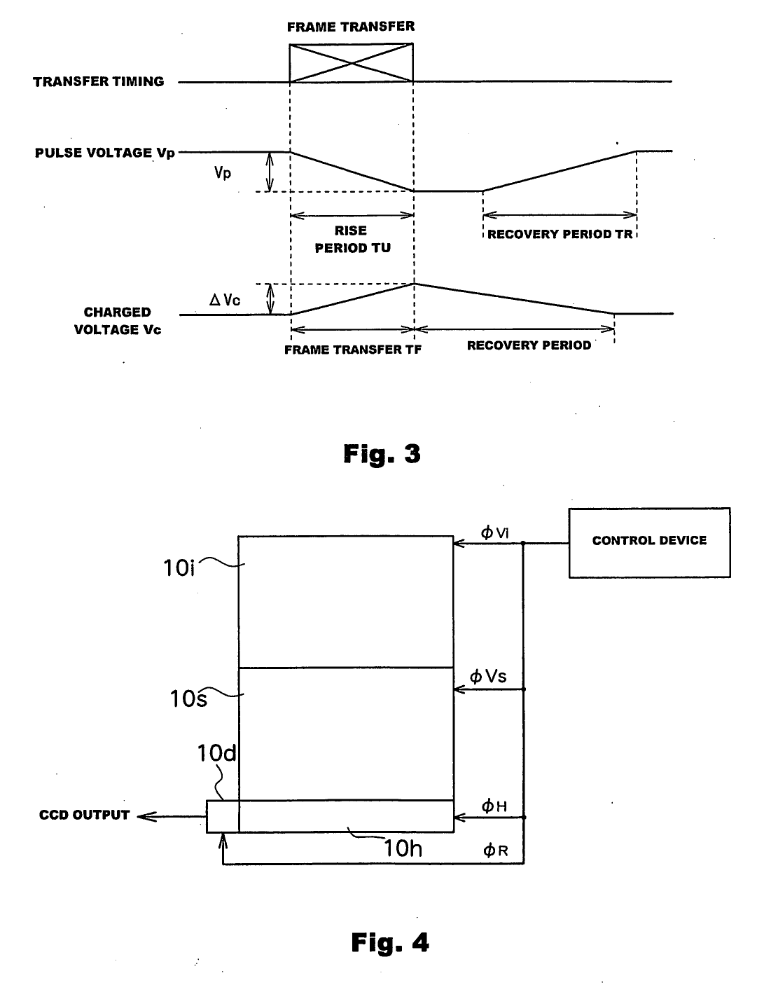

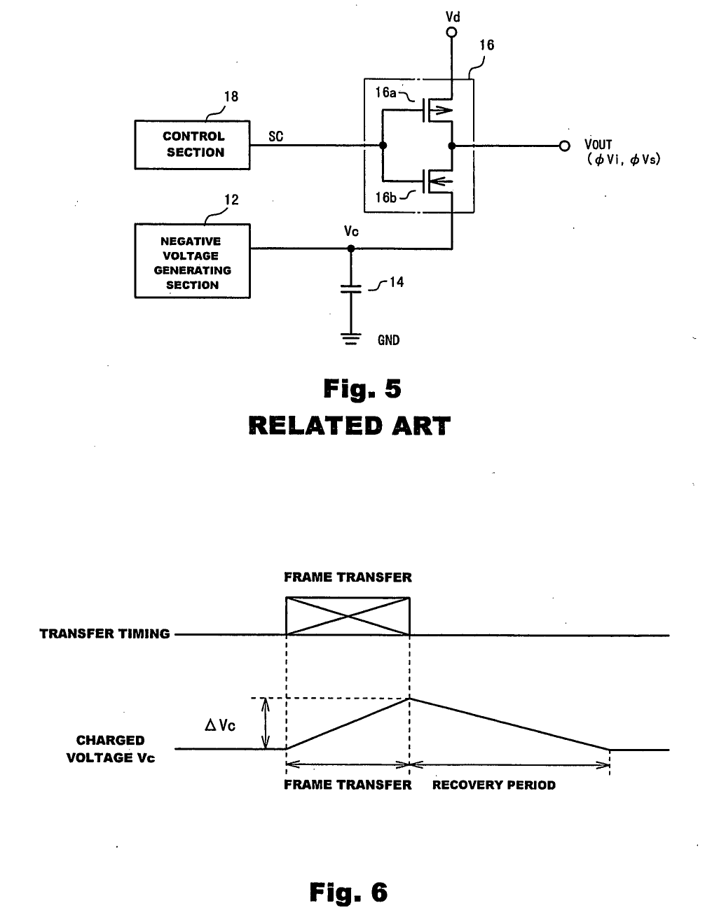

Further, the control section 28 causes the pulse generating section 30 to generate a pulse voltage in synchronism with the points in time at which the charged voltage of the capacitor 24 varies. For example, the control section 28 outputs the pulse control signal SP to the pulse generating section 30. The control section 28 thus performs control such that the pulse generating section 30 generates a pulse voltage in synchronism with points in time at which the inverter 26, a switch circuit, outputs the charged voltage to the capacitor 24. Specifically, as shown in FIG. 3, while no frames are transferred, the control section 28 maintains the pulse control signal SP at the low level (negative voltage). This turns on the transistor 30a, while turning off the transistor 30b, thus maintaining a pulse voltage V_{P} from the pulse generating section 30 at a positive value. To start transferring frames, the control section 30 changes the pulse control signal SP to the high level (positive potential). This changes the pulse voltage V_{P} from the pulse generating section 30 to the ground potential when the frames start to be transferred.

The pulse voltage V_{P} is superimposed on the charged voltage of the capacitor 24. When the frame transfer starts, a variation in pulse voltage V_{P} compensates for a variation in the charged voltage Vc of the capacitor 24 to suppress a variation ΔVc in the charged voltage Vc of the capacitor 14. This in turn suppresses a variation in output voltage V_{OUT} (vertical clock pulses φᵥᵢ and φᵥₛ) from the inverter 26. Therefore, information charges for the frames can be stably transferred.

In this case, a rise time T_{U} for the pulse voltage V_{P} is set shorter than the period T_{F} of frame transfer. A recovery time T_{R} for the pulse voltage V_{P} is preferably set within the length of time after the frame transfer ends and before the next image is picked up. The recovery time T_{R} is suitably set longer than the rise time T_{U} for the pulse voltage V_{P}.

For example, if the pulse generating section 30 includes the inverter circuit shown in FIG. 2, the recovery time T_{R} for the pulse voltage V_{P} can be set longer than the rise time T_{U} for the pulse voltage V_{P} by setting the capacitance of the transistor 30b larger than that of the transistor 30b.

As described above, the present embodiment can reduce the magnitude of a variation in the control voltage for the charge transfer element. Therefore, changes can be stably transferred. Moreover, according to the present embodiment, the total capacitance of the capacitor can be reduced to about half the capacitor capacitance value required for the conventional control device to suppress a variation in control voltage. Even if the control device includes the newly added pulse generating section 30, the size of the whole circuit can be made about equal to or smaller than that of the conventional one.

In the description of the present embodiment, the control device uses, by way of example, the negative voltage generating section 22 generating a negative voltage. However, the present invention can produce similar effects even if it is applied to a control device having a power generating section that generates a positive voltage.

1. A control device characterized by comprising:
a first capacitor and a second capacitor;
a voltage generating section that outputs a voltage from an output end connected to an end of the first capacitor;
a pulse generating section that outputs a pulse voltage, on the basis of a pulse control signal, from an output end connected to the output end of the voltage generating section via the second capacitor; and
a control section that controls the pulse control signal so that the pulse generating section outputs a pulse voltage at predetermined points in time.

2. The control device according to claim 1, characterized by further comprising:
a switch circuit that outputs a charged voltage of the first capacitor externally at predetermined points in time on the basis of a clock control signal, and wherein
the control section outputs the clock control signal to the switch circuit and controls the pulse control signal in accordance with the points in time at which the clock control signal is output.

3. A control device characterized by comprising:
a voltage generating section that outputs a voltage from an output end that can be connected to an end of a first capacitor;
a pulse generating section that outputs a pulse voltage, on the basis of a pulse control signal, from an output end that can be connected to the output end of the voltage generating section via a second capacitor; and
a control section that controls the pulse control signal so that the pulse generating section outputs a pulse voltage at predetermined points in time.

4. The control device according to claim 3, characterized by further comprising:
a switch circuit that outputs a charged voltage of the first capacitor externally at predetermined points in time on the basis of a clock control signal, and wherein
the control section outputs the clock control signal to the switch circuit and controls the pulse control signal in accordance with the points in time at which the clock control signal is output.

5. The control device according to claim 1, characterized in that the control section controls the pulse control signal so that the pulse generating section generates a pulse voltage in synchronism with points in time at which the charged voltage of the first capacitor varies.

6. The control device according to claim 3, characterized in that the control section controls the pulse control signal so that the pulse generating section generates a pulse voltage in synchronism with points in time at which the charged voltage of the first capacitor varies.

7. The control device according to claim 2, characterized in that the control section controls the pulse control signal so that the pulse generating section generates a pulse voltage in synchronism with points in time at which the switch circuit outputs the charged voltage of the first capacitor.

8. The control device according to claim 4, characterized in that the control section controls the pulse control signal so that the pulse generating section generates a pulse voltage in synchronism with points in time at which the switch circuit outputs the charged voltage of the first capacitor.

9. The control device according to claim 1, characterized in that a recovery period for the pulse voltage generated by the pulse generating section is set longer than a rise period for the pulse voltage.

10. The control device according to claim 3, characterized in that a recovery period for the pulse voltage generated by the pulse generating section is set longer than a rise period for the pulse voltage.

11. A charge transfer device based on a frame transfer type, the charge transfer device comprising the control device according to claim 1, the charge transfer device being characterized in that the control section controls the pulse control signal so that the pulse generating section generates a pulse voltage in synchronism with points in time at which frames of charges start to be transferred.

12. A charge transfer device based on a frame transfer type, the charge transfer device comprising the control device according to claim 3, the charge transfer device being characterized in that the control section controls the pulse control signal so that the pulse generating section generates a pulse voltage in synchronism with points in time at which frames of charges start to be transferred.
